(19) United States
(12) Patent Application Publication
(10) Pub. No.: US 2009/0006399 A1
(43) Pub. Date: Jan. 1, 2009

(54) COMPRESSION METHOD FOR RELATIONAL TABLES BASED ON COMBINED COLUMN AND ROW CODING

(75) Inventors: Vijayshankar Raman, Sunnyvale, CA (US); Garret Swart, Palo Alto, CA (US)

Correspondence Address: IP AUTHORITY, LLC;RAMRAJ SOUNDARARAJAN, 4821A Eisenhower Ave, Alexandria, VA, 22304, US

(73) Assignee: INTERNATIONAL BUSINESS MACHINES CORPORATION, ARMONK, NY (US)

(21) Appl. No.: 11/772,058

(22) Filed: Jun. 29, 2007

(51) Int. Cl. G06F 7/00

(52) U.S. Cl. 707/7; 707/E17.046

(57) ABSTRACT

A robust method to compress relations close to their entropy while still allowing efficient queries. Column values are encoded into variable length codes to exploit skew in their frequencies. The codes in each tuple are concatenated and the resulting tuplecodes are sorted and delta-coded to exploit the lack of ordering in a relation. Correlation is exploited either by co-coding correlated columns, or by using a sort order that can leverage the correlation. Also presented is a novel Huffman coding scheme, called segregated coding, that preserves maximum compression while allowing range and equality predicates on the compressed data, without even accessing the full dictionary. Delta coding is exploited to speed up queries, by reusing computations performed on nearly identical records.

### BACKGROUND OF THE INVENTION

1. Field of Invention

The present invention relates generally to the field of data processing and compression schemes used o combat bottlenecks in data processing. More specifically, the present invention is related to a compression method for relational tables based on combined column and row coding.

2. Discussion of Prior Art

Data movement is a major bottleneck in data processing. In a database management system (DBMS), data is generally moved from a disk, though an I/O network, and into a main memory buffer pool. After that it must be transferred up through two or three levels of processor caches until finally it is loaded into processor registers. Even taking advantage of multi-task parallelism, hardware threading, and fast memory protocols, processors are often stalled waiting for data; the price of a computer is often determined by the quality of its I/O and memory system, not the speed of its processor. Parallel and distributed DBMSs are even more likely to have processors that stall waiting for data from another node. Many DBMS “utility” operations such as replication, ETL (extract-transform and load), and internal and external sorting are also limited by the cost of data movement1.

DBMSs have traditionally used compression to alleviate this data movement bottleneck. For example, in IBM's DB2 DBMS, an administrator can mark a table as compressed, in which case individual records are compressed using a dictionary scheme [See paper to Iyer et al. titled “Data Compression Support in Data Bases” in VLDB 1994]. While this approach reduces I/Os, the data still needs to be decompressed, typically a page or record at a time, before it can be queried. This decompression increases CPU cost, especially for large compression dictionaries that don't fit in cache. Worse, since querying is done on uncompressed data, the in-memory query execution is not speeded up at all. Furthermore, as we see later, a vanilla gzip or dictionary coder leads to inefficient compression—we can do better by exploiting the semantics of relations.

Another popular method that addresses some of these issues is column value coding [see paper to Antoshenkov et al. titled “Order Preserving String Compression” in ICDE, 1996 and paper to Stonebraker et al. titled “C-Store: A Column Oriented DBMS” in VLDB, 2005, and see paper to Goldsteinet al. titled “Compressing Relations and Indexes” in ICDE, 1998, and see paper titled “Sybase IQ” on Sybase's web site]. The approach here is to encode values in each column into a tighter representation, and then run queries directly against the coded representation. For example, values in a CHAR(20) column that takes on only 5 distinct values can be coded with 3 bits. Often such coding is combined with a layout where all values from a column are stored together [See paper to Ailamaki et al. titled “Weaving relations for cache performance” in VLDB 2001, and paper to Stonebraker et al. titled “C-Store: A Column Oriented DBMS” in VLDB, 2005, and see paper titled “Sybase IQ” on Sybase's web site]. The data access operations needed for querying—scan, select, project, etc.—then become array operations that can usually done with bit vectors coding is combined with a layout where all values from a column are stored together [See paper to Ailamaki et al. titled “Weaving relations for cache performance” in VLDB 2001 and paper to Stonebraker et al. titled “C-Store: A Column Oriented DBMS” in VLDB, 2005, and see paper titled “Sybase IQ” on Sybase's web site]. The data access operations needed for querying—scan, select, project, etc.—then become array operations that can usually done with bit vectors.

Whatever the precise merits, features, and advantages of the above cited references, none of them achieves or fulfills the purposes of the present invention.

### SUMMARY OF THE INVENTION

The present invention provides for a computer-based method of compressing tabular data, wherein the computer-based method implemented in computer storage and executable by a computer and the computer-based method comprises the steps of: concatenating a plurality of column values forming a combined value to exploit correlation between those columns; encoding column values based on replacing column values with a column code that is a key into a dictionary of column values; concatenating the column codes within each row to form a tuple code; and outputting the tuple code.

The present invention provides for an article of manufacture a computer user medium having computer readable program code embodied therein which implements a method of compressing tabular data, wherein the medium comprises: computer readable program code concatenating a plurality of column values forming a combined value to exploit correlation between those columns; computer readable program code encoding column values based on replacing column values with a column code that is a key into a dictionary of column values; concatenating the column codes within each row to form a tuple code; and computer readable program code outputting the tuple code.

### BRIEF DESCRIPTION OF THE DRAWINGS

FIG. 1 illustrates an embodiment of the present invention that teaches a computer-based method of compressing tabular data.

FIG. 2 illustrates an ‘Algorithm A’—pseudo-code for compressing a relation.

FIG. 3 illustrates a flow chart depicting the compression process.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Although it is very useful, column value coding alone is insufficient, because it poorly exploits three sources of redundancy in a relation:
Skew: Real-world data sets tend to have highly skewed value distributions. Column value coding assigns fixed length (often byte aligned) codes to allow fast array access. But it is inefficient, especially for large domains, because it codes infrequent values in same number of bits as frequent values.
Correlation: Consider two columns, an order ship data and an order receipt date. Taken separately, both dates may have the same value distribution, and may be coded in the same number of bits by a scheme that codes them separately. However, the receipt date is likely to be clustered around a certain distance from the ship date. Thus, once the ship date has been chosen, the probability distribution of the receipt date has been constrained significantly and it can be coded in much less space than is needed to code an independent date. Data domains tend to have many such correlations, and they provide a valuable opportunity for compression.
Order-Freeness: Relations are multisets of tuples, rather than sequences of tuples. So a physical representation of a relation is free to choose its own order—or no order at all. This flexibility is traditionally used for clustering indexes. However, we shall see that this representation flexibility can also be exploited for additional, often substantial, compression.

Column and Row Coding

This paper presents a new compression method based on a mix of column and tuple coding.

Briefly, our method composes three steps. We encode column values with variable length Huffman codes [see paper to Huffman titled “Method for the construction of minimum redundancy codes” in the Proc. I.R.E., 1952] in order to exploit skew in the frequencies of the values. We then concatenate the codes within each tuple to form tuplecodes and lexicographically sort and delta code these tuplecodes, to take advantage of the lack of ordering of relations. We exploit correlation between columns within a tuple by using one of two methods: we either concatenate values in the correlated columns and assign them a single Huffman code, or we leave the columns separate and place them early in the lexicographic ordering, and rely on delta coding to exploit the correlation. We also exploit specialized domain-specific coding techniques applied before the Huffman coding.

We define a notion of entropy for relations, and prove that our method is near-optimal under this notion, in that it asymptotically compresses a relation to within 4.3 bits/tuple of its entropy. We also report on experiments with this method on both real data sets from IBM customers, and on synthetic datasets (vertical partitions from the TPC-H dataset). In our experiments we obtain compression factors of 10 to 37, vs 1 to 5 reported for prior methods.

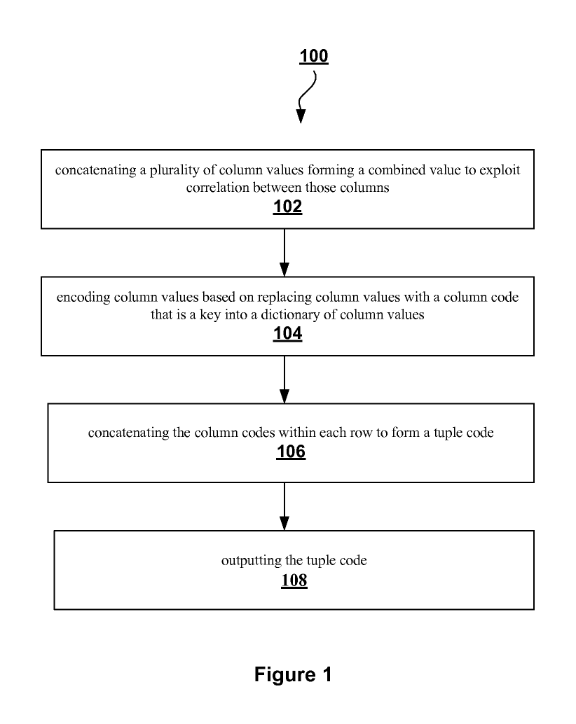

FIG. 1 illustrates one embodiment of the present invention that teaches a computer-based method 100 of compressing tabular data, said computer-based method implemented in computer storage and executable by a computer, wherein the computer-based method comprising the steps of: concatenating a plurality of column values forming a combined value to exploit correlation between those columns 102; encoding column values based on replacing column values with a column code that is a key into a dictionary of column values 104; concatenating the column codes within each row to form a tuple code 106; and outputting the tuple code 108.

Efficient Querying Over Compressed Data

In addition to improved compression, we also investigate querying directly over the compressed data (Section 3). This keeps our memory working set size small, and also saves decompression costs on columns and rows that need not be accessed (due to selections/projections).

Querying compressed data involves parsing an encoded bit stream into records and fields, evaluating predicates on the encoded fields, and computing joins and aggregations. Prior researchers using value coding have suggested order-preserving codes [see papers to Antoshenkov et al. titled “Order Preserving String Compression” in ICDE, 1996, and see the paper to Hu et al. titled “Optimal computer search trees and variable-length alphabetic codes” in SIAM J. Appl. Math, 1971, and the paper to Zandi et al. titled “Sort Order Preserving Data Compression for Extended Alphabets” in the Data Compression Conference, 1993] that allow some predicate evaluation on encoded fields. But this method does not easily extend to variable length codes. Even tokenizing a record into fields, if done naively, involves navigation over several Huffman dictionaries. These dictionaries tend to be large and not fit in cache, so the basic operation of scanning a tuple and applying selection/projection becomes expensive. We use 3 optimizations to speed up querying:

Segregated Coding: Our first optimization is a novel coding scheme for prefix code trees. Unlike a true order preserving code, we preserve ordering only within codes of the same length. This allows us to evaluate many common predicates directly on the coded data, and also find the length of each codeword without accessing the Huffman dictionary, thereby reducing the memory working set of tokenization and predicate evaluation.

Parse Reuse: Our delta coding scheme lexicographically sorts the tuplecodes, and then replaces each tuplecode with its delta from the previous tuplecode. A side-effect of this process is to cluster tuples with identical column values together, especially for columns that are early in the lexicographic order. Therefore, as we scan each tuple, we avoid re-computing selections and projections on columns that are unchanged from the previous tuple.

Column Reordering: Even with order-preserving codes, columns used in arithmetic expressions or like predicates must be decoded. But lexicographic sorting creates a locality of access to the Huffman dictionary. So we carefully place columns that need to be decoded early in the lexicographic order, to speed up their decoding.

1.1 Background and Related Work

Information Theory

The theoretical foundation for much of data compression is information theory [see paper to Cover et al. titled “Elements of Information Theory” in John Wiley, 1991]. In the simplest model, it studies the compression of sequences emitted by 0^{th}-order information sources—ones that generate values i.i.d. per a probability distribution D. Shannon's celebrated source coding theorem [see paper to Cover et al. titled “Elements of Information Theory” in John Wiley, 1991] says that one cannot code a sequence of values in less than H(D) bits per value on average, where

$$H ( D ) = \sum {p}_{i} lg ( \frac{1}{{p}_{i}} )$$

is called the entropy of the distribution D (pᵢ's are probabilities).

Several well studied codes like Huffman code and Shannon-Fano code achieve 1+H(D) bits/tuple asymptotically, typically using a dictionary that maps values in D to codewords. A value with occurrence probability pᵢ is coded in roughly

$$lg ( \frac{1}{{p}_{i}} )$$

bits—more frequent values are coded in fewer bits.

The most common coding schemes are prefix codes—no codeword is a prefix of another codeword. So the dictionary is implemented as a prefix tree where edges are labeled 0/1 and leaves correspond to codewords. By walking the tree one can unambiguously tokenize a string of codewords, without any delimiters—every time we hit a leaf we output a codeword and jump back to the root.

The primary distinction between relations and the information sources considered in information theory is order-freeness; relations are multisets, and not sequences. A secondary distinction is that we want the compressed data to be directly queryable, whereas it is more common in information theory for the sequence to be decompressed and then pipelined to any application.

Related Work on Database Compression

DBMSs have long used compression to alleviate their data movement problems. The literature has proceeded along two strands: field wise compression, and row wise compression.

Field Wise Compression: [see paper to Graefe et al. titled “Data Compression and Database Performance” in Symposium on Applied Computing, 1991] is among the earliest papers to propose field-wise compression, because only fields in the projection list need to be decoded. They also observe that operations like join that involve only equality comparisons can be done without decoding. [see paper to Goldsteinet al. titled “Compressing Relations and Indexes” in ICDE, 1998] propose to store a separate reference for the values in each page, resulting in smaller codes. Many column-wise storage schemes [See paper to Ailamaki et al. titled “Weaving relations for cache performance” in VLDB 2001 and paper to Stonebraker et al. titled “C-Store: A Column Oriented DBMS” in VLDB, 2005, and see paper titled “Sybase IQ” on Sybase's web site] also compress values within a column. Some researchers have investigated order-preserving codes in order to allow predicate evaluation on compressed data [see papers to Antoshenkov et al. titled “Order Preserving String Compression” in ICDE, 1996, and see the paper to Hu et al. titled “Optimal computer search trees and variable-length alphabetic codes” in SIAM J. Appl. Math, 1971, and the paper to Zandi et al. titled “Sort Order Preserving Data Compression for Extended Alphabets” in the Data Compression Conference, 1993]. An important practical issue is that field compression can make fixed-length fields into variable-length ones. Parsing and tokenizing variable length fields increases the CPU cost of query processing, and field delimiters, if used, undo some of the compression. So many of these systems use fixed length codes, mostly byte-aligned. This approximation can lead to substantial loss of compression as we see in Section 2.1.1. Moreover, column coding cannot exploit correlation or order-freeness. Our experiments in Section 4 suggest that these can add an extra factor of 10 to 15 compression.

Row Wise Compression: Commercial DBMS implementations have mostly followed the other strand, of row or page level compression. IBM DB2 [See paper to Iyer et al. titled “Data Compression Support in Data Bases” in VLDB 1994] and IMS [see paper by Cormack titled” Data Compression In a Database System” in Communications of the ACM, 1985] use a non-adaptive dictionary scheme, with a dictionary mapping frequent symbols and phrases to short code words. Some experiments on DB2 [See paper to Iyer et al. titled “Data Compression Support in Data Bases” in VLDB 1994] indicate about a factor of 2 compression. Oracle also uses a dictionary of frequently used symbols to do page-level compression, and report 2× to 4× compression [see paper to Poess et al. titled “Data compression in Oracle” in VLDB, 2003]. The main advantage of row/page compression is that it is simpler to implement in an existing DBMS, because the code changes are contained within the page access layer. But it has a huge disadvantage that the memory working set is not reduced at all. So it is of little help on modern hardware where memory is plentiful and CPU is mostly waiting on cache misses. Some studies also suggest that the decompression cost is also quite high, at least with standard zlib libraries [see paper to Goldsteinet al. titled “Compressing Relations and Indexes” in ICDE, 1998].

Delta Coding: C-Store [see paper to Stonebraker et al. titled “C-Store: A Column Oriented DBMS” in VLDB, 2005] is an interesting recent column-wise system that does column-wise storage and compression. One of its compression alternatives is to delta code the sort column of each table. This allows some exploitation of the order-freeness. [see paper to Stonebraker et al. titled “C-Store: A Column Oriented DBMS” in VLDB, 2005] does not state how the deltas are encoded, so it is hard to gauge the extent to which the order-freeness is exploited; it is restricted to the sort column in any case. In a different context, inverted lists in search engines are often compressed by computing deltas among the URLs, and using heuristics to assign short codes to common deltas (e.g., see paper to Bharat et al. titled “The connectivity server: Fast access to linkage information on the web” in WWW, 1998). We are not aware of any rigorous work showing that delta coding can compress relations close to their entropy.

Lossy Compression: There is a vast literature on lossy compression for images, audio, etc. There has been comparatively less work for relational data (e.g., see paper to Babu et al. titled “SPARTAN: A model-based semantic compression system for massive tables” in SIGMOD, 2001). These methods are complementary to our work—any domain-specific compression scheme can be plugged in as we show in Section 2.1.4. It is believed that lossy compression can be useful for measure attributes that are used only for aggregation.

2. Compression Method

Three factors lead to redundancy in relation storage formats: skew, tuple ordering, and correlation. In Section 2.1 we discuss each of these in turn, before presenting a composite compression algorithm that exploits all three factors to achieve near-optimal compression. Such extreme compression is ideal for pure data movement bound tasks like backup. But it is at odds with efficient querying. Section 2.2 describes some relaxations that sacrifice some compression efficiency in return for simplified querying. This then leads into a discussion of methods to query compressed relations, in Section 3.

2.1 Squeezing Redundancy Out of a Relation

2.1.1 Exploiting Skew by Entropy Coding

Many domains have highly skewed data distributions. One form of skew arises from representation—a schema may model values from a domain with a data type that is much larger. E.g., in TPC-H, C_MKTSEGMENT has 5 distinct values but is modeled as CHAR(10)—out of 280 distinct 10-byte strings, only 5 have non-zero probability of occurring! Likewise, dates are often stored as eight 4 bit digits (mmddyyyy), but the vast majority of the 168 possible values correspond to illegal dates.

Prior work exploits this by what can be termed value coding (e.g, see paper to Stonebraker et al. titled “C-Store: A Column Oriented DBMS” in VLDB, 2005, and see paper titled “Sybase IQ” on Sybase's web site) values from a domain are coded with a data type of matching size—e.g., C_MKTSEGMENT can be coded as a 3 bit number. To permit array based access, each column is coded in a fixed number of bits.

TABLE 1

| | | Num. Likely vals | | |
|---|---|---|---|---|
| | Num. possible | (in top 90 | Entropy | |
| Domain | values | percentile) | (bits/value) | Comments |
| Ship Date | | | | 99% of dates are in 1995-2005, |
| | | | | 99% of those are weekdays, 40% |
| | | | | of those are in 20 days before New |
| | | | | Year and Mother's day. |
| Last Names | 2¹⁶⁰ (char(20)) | 80000 | 26.81 | We use exact frequencies for all |
| Male first names | 2¹⁶⁰ (char(20)) | 1219 | 22.98 | U.S. names ranking in the top 90 |
| | | | | percentile (from census.gov), and |
| | | | | extrapolate, assuming that all .2160 |
| | | | | names below 10th percentile are |
| | | | | equally likely. This over-estimates |
| | | | | entropy. |
| Customer Nation | 215 ≈ 2^{7.75} | 2 | 1.82 | We use the country distribution |
| | | | | from import statistics for Canada |
| | | | | (from www.wto.org) - the entropy |
| | | | | will be less if we factor in poor |
| | | | | countries, which trade much less |
| | | | | and mainly with their immediate |
| | | | | neighbors. |

While useful, this method does not address skew within the value distribution. Many domains have long-tailed frequency distributions where the number of possible values is much more than the number of likely values. Table 1 lists a few such domains. Specifically, Table 1 depicts skew and entropy in some common domains. For example, 90% of male first names fall within 1219 values, but to catch all corner cases we would need to code it as a CHAR(20), using 160 bits vs 22.98 bits of entropy. We can exploit such skew fully through “entropy coding”.

Probabilistic Model of a Relation

Consider a relation R with column domains COL₁, . . . COLₖ. For purposes of compression, we view the values in COLᵢ as being generated by an i.i.d (independent and identically distributed) information source per a probability distribution Dᵢ. Tuples of R are viewed as being generated by an i.i.d information source with joint probability distribution: D=(D₁, D₂, . . . Dₖ)².

By modeling the tuple sources as i.i.d., we lose the ability to exploit inter-tuple correlations. To our knowledge, no one has studied such correlations in databases—all the work on correlations has been among fields within a tuple. If inter-tuple correlations are significant, the information theory literature on compression of non zero-order sources might be applicable.

We can estimate each Dᵢ from the actual value distribution in COLᵢ, optionally extended with some domain knowledge. For example, if COLi has {Apple, Apple, Banana, Mango, Mango, Mango}, Di is the distribution: {p(Apple)=0.333, p(Banana)=0.166, p(Mango)=0.5}.

Schemes like Huffman and Shannon-Fano code such a sequence of i.i.d values by assigning shorter codes to frequent values [see paper to Cover et al. titled “Elements of Information Theory” in John Wiley, 1991]. On average, they can code each value in COLᵢ with <1+H(Dᵢ) bits, where H(X) is the entropy of distribution X—hence they are also called “entropy codes”. Using an entropy coding scheme, we can code R with Σ_{1≦i≦k}(|R|(1+H(Dᵢ))+DictSize(COLᵢ)) where DictSize(COLᵢ) is the size of the dictionary mapping code words to values of COLᵢ.

If a relation were a sequence of tuples, assuming that the domains Di are independent (we relax this in 2.1.3), this coding is optimal, by Shannon's source coding theorem [see paper to Cover et al. titled “Elements of Information Theory” in John Wiley, 1991]. But relations are sets of tuples, and permit further compression.

M H(deltas) in bits

10000 1.897577

Entropy of deltas in m values picked uniformly and i.i.d from [1,m] (100 trials)

2.1.2 Order: Delta Coding Multi-Sets

Consider a relation R with just one column COL₁, containing m numbers chosen uniformly and i.i.d from [1..m]. Traditional databases would store R in a way that encodes both the content of R and some incidental ordering of its tuples. Denote this order-significant view of the relation as R (we use bold font to indicate a sequence).

The number of possible instances of R is m^{m}, each of which has equal likelihood, so we need m 1 g m bits to represent one instance. But R needs much less space because we don't care about the ordering. Each distinct instance of R corresponds to a distinct outcome of throwing of m balls into m equal probability bins. So, by standard combinatorial arguments [see paper to Weisstein et al. “Catalan Number” in MathWorld] (see the book published by Macmillan India Ltd. in 1994 to Barnard et al. titled “Higher Algebra”), there

$$( \begin{matrix}2 m - 1 \\ m\end{matrix} ) \approx \frac{{4}^{m}}{\sqrt{( 4 π m )}}$$

choices for R, which is much less than m^{m}. A simple way to encode R is as a delta sequence:

1) Sort the entries of R, forming sequence v=v₁ . . . vₘ

2) Form a delta sequence v₂−v₁, v₃−v₂, . . . vₘ−vₘ₋₁.

3) Entropy code the values in delta to form a new sequence CodedDelta(R)=code(v₂−v₁) . . . code(vₘ−vₘ₋₁)

Space Savings by Delta Coding

Intuitively, delta coding compresses R because small deltas are much more common than large ones. Formally:

Lemma 1: For a multiset R of m values picked uniformly with repetition from [1,m], and m>20, the value distribution in CodedDelta(R) has entropy<3.3 bits.

This bound is far from tight. Table 2 shows results from a Monte-Carlo simulation (100 trials) where we pick m numbers i.i.d from [1,m], calculate the frequency distribution of deltas, and thereby their entropy. Notice that the entropy is always less than 2 bits. Delta coding compresses R from m 1 g m bits to 1 g m+(m−1)2 bits. For moderate to large databases, 1 g m is about 30 (e.g., 100 GB at 100 B/row). This translates into up to a 10 fold compression.

TABLE 2

| M | H(deltas) in bits |
|---|---|
| 10000 | 1.897577 |
| 100000 | 1.897808 |
| 1000000 | 1.897952 |
| 10000000 | 1.89801 |
| 40000000 | 1.898038 |

This analysis applies to a relation with one column, chosen uniformly from [1,m]. We generalize this to a method that works on arbitrary relations in Section 2.1.4.

Optimality of Delta Coding

Such delta coding is also very close to optimal—the following lemma shows we cannot reduce the size of a multiset by more than 1 g m!.

Lemma 2: Given a vector R of m tuples chosen i.i.d. from a distribution D and the multi-set R of values in R, (R and R are both random variables), H(R)>=m H(D)−1 g m!

Proof: Sketch: Since the elements R are chosen i.i.d., H(R)=m H(D). Now, augment the tuples t1 t2 . . . tm of R with a “serial-number” column sno, where tᵢ. sno=i. Ignoring the ordering of tuples in this augmented vector, we get a set, call it R1. Clearly there is a bijection from R1 to R, so H(R1)=m H(D). But R is just a projection of R1, on all columns but sno. For each relation R, there are at most m! relations R1 whose projection is R. So H(R1)<=H(R)+1 g m!, and we have the result.

So, we are off by at most 1 g m!−m(1 g m−2)≈m(1 g m−1 g e)−m(1 g m−2)=m(2-1 g e)≈0.6 bits/tuple from the best possible compression. This loss occurs because the deltas are in fact mildly correlated (e.g., sum of deltas=m), but we do not exploit this correlation—we code each delta separately to allow pipelined decoding.

2.1.3 Correlation

Consider a pair of columns (partKey, price), where each partKey largely has a unique price. Storing both partKey and price is wasteful; once the partKey is known, the range of values for price is limited. Such inter-field correlation is quite common and is a valuable opportunity for relation compression.

In Section 2.1.1, we coded each tuple in ΣⱼH(Dⱼ) bits. This is optimal only if the column domains are independent, that is if the tuples are generated per an independent joint distribution (D₁, D₂, . . . Dₖ). For any distribution D₁ . . . Dₖ, H(D₁, D₂, . . . Dₖ)<=Sⱼ H(Dⱼ) with equality iff the Dⱼ's are independent [see paper to Cover et al. titled “Elements of Information Theory” in John Wiley, 1991]. Thus any correlation strictly reduces the entropy.

To exploit this correlation, we first identify the subsets of columns that are strongly correlated (we can do this either manually or via a statistical sampling scheme like [see paper to Ilyas et al. titled “CORDS: Automatic discovery of correlations and soft functional dependencies” in SIGMOD, 2004]). We then concatenate values in these columns and co-code them, using a single dictionary3. Another approach is to learn a Markov model for the source generating the field values [see Cormack et al. “Data Compression using Dynamic Markov Modelling” in Computer Journal, 1987] within a tuple. But this makes querying much harder; to access any field we have to decode the whole tuple.

2.1.4 Composite Compression Algorithm

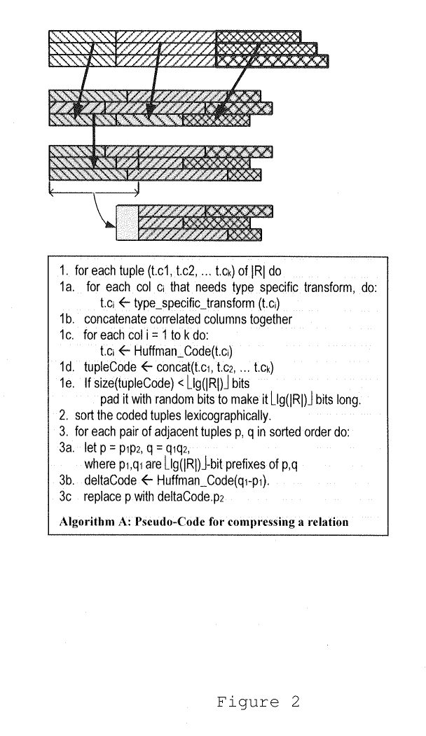

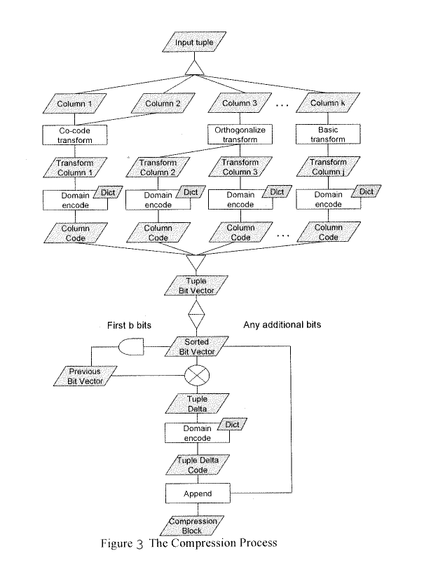

Having seen basic kinds of compression possible, we now proceed to design a composite compression algorithm that exploits all three forms of redundancy. A further design goal is to allow users to plug in custom compressors for idiosyncratic data types (images, text, etc). FIG. 2 gives an example of how the data is transformed. Specifically, FIG. 2 illustrates an ‘Algorithm A’—pseudo-code for compressing a relation. FIG. 3 gives a process flow chart. The algorithm has two main pieces:

Column Coding: On each tuple, we first perform any type specific transforms (1a), concatenate correlated columns (1b), and then replace each column value with a field code. We use Huffman codes because they are asymptotically optimal, and we have developed a method to efficiently run selections and projections on concatenated Huffman codes (Section 3). We compute the codes using a statically built dictionary rather than a Ziv-Lempel style adaptive dictionary because data is typically compressed once and queried many times, so the extra effort on developing a better dictionary pays off.

Tuple Coding: We then concatenate all field codes to form a bit-vector for each tuple, pad them to 1 g (|R|) bits and sort the bit-vectors lexicographically. These bit vectors are called tuplecodes. After sorting, the tuplecodes are delta-coded on their initial 1 g(|R|) bits, with a Huffman code of the deltas replacing the original values.

The expensive step in this process is the sort. But it need not be perfect, as any imperfections only reduce the compression. For example, if the data set is too large to sort in memory, we can merely create memory-sized sorted runs and not do a final merge; we lose about 1 g× bits per tuple, if we have x similar sized runs.

Analysis of Compression Efficiency

Lemma 2 gives a lower bound on the compressibility of a general relation: H(R)>=m H(D)−1 g m!, where m=|R|, and tuples of R are chosen i.i.d from a joint distribution D. The Huffman coding of the column values reduces the relation size to mH(D) asymptotically. Lemma 1 shows that, for a multiset of m numbers chosen uniformly from [1,m], delta coding saves almost 1 g m! bits. But the analysis of Algorithm A is complicated because (a) our relation R need not be such a multiset, and (b) because of the padding we have to do in Step 1e. Nevertheless, we can show that we are within 4.3 bits/tuple of the optimal compression:

Theorem 1: On average, Algorithm A compresses a relation R of tuples chosen i.i.d per a distribution D to at most H(R)+4.3|R| bits, if |R|>100

2.2 Relaxing Compression Efficiency for Query and Update Efficiency

Having seen how to maximally compress, we now study relaxations that sacrifice some compression in return for faster querying.

2.2.1 Huffman Coding vs Value Coding

As we have discussed, Huffman coding can be substantially more efficient than value coding for skewed domains. But it does create variable length codes, which are harder to tokenize or apply predicates on (Section 3). So it is useful to do value coding on certain domains, where any skew is mostly in representation, and value coding compresses almost as well as Huffman coding.

Consider a domain like “supplierKey integer”, for a table with a few hundred suppliers. Using a 4 byte integer is obviously over-kill. But if the distribution of suppliers is roughly uniform, a 10-bit value code may compress the column close to its entropy. Another example is “salary integer”. If salary ranges from 1000 to 500000, storing it as a fixed length 20 bit integer may be okay. The advantage of such value codes is: (a) they are fixed length and so trivial to tokenize, (b) they are often decodable through a simple arithmetic formula. The latter is important when aggregations are involved, because even with order preserving codes, we cannot compute aggregations without decoding.

We use value coding as a default for key columns (like suppkey) as well as columns on which the workload queries perform aggregations (salary, price,

2.2.2 Tuning Sort Order to Obviate Co-Coding

In Section 2.1.3, we co-coded correlated columns to achieve greater compression. But co-coding can make querying harder. Consider the example (partKey, price) again. We can evaluate a predicate partKey=_ AND price=_ on the cocoded values if the cocoding scheme preserves the ordering on (partKey,price). We can also evaluate standalone predicates on partKey. But we cannot evaluate a predicate on price without decoding.

To avoid co-coding such column pairs (where some queries have standalone predicates n both columns), we tune the lexicographic sort order of the delta coding. Notice that in Step 1d of Algorithm A, there is no particular order in which the fields of t should be concatenated—we can choose any concatenation order, as long as we follow the same for all the tuples. Say we code partKey and price separately, but place partKey followed by price early in the concatenation order in Step 1d. After sorting, identical values of partKey will mostly appear together. Since partKey largely determines price, identical values of price will also appear close together! So the contribution of price to the deltaCode (Step 3b) is a string of 0s most of the time. This 0-string compresses very well during the Huffman coding of the deltaCodes. We present experiments in Section 4 that quantify this tradeoff.

2.2.3 Change Logs for Efficient Updates

A naïve way of doing updates is to re-compress after each batch of updates. This may be ok if the database has well-defined update and query windows. Otherwise, we propose the following incremental update scheme.

When a new batch of tuples is inserted into a table T, we have to (a) assign Huffman codes to their fields, and (b) compute delta codes.

Growing the Dictionary: Assigning Huffman codes is trivial if the field values already have entries in the corresponding dictionaries. This is often the case after the optimization of Section 2.2.1, because we only Huffman code “dimension” columns such as products, nations, and new entries arise only occasionally for such domains (the common insert is to the fact table, using prior values).

But if the inserted tuples have new values, we need to grow the dictionary to get new codewords. To allow such extension, we always keep in the dictionary a very low frequency default value called unknown. When a new batch of values needs to be coded, we first compute their codewords using their frequency in the new batch of inserts, and then append these to code(unknown).

Delta Coding: Once the Huffman codes are assigned, we compute a concatenated tuplecode for each new tuple. We append these new tuples to a change-table CT, and sort and assign delta codes within this change table. CT is obviously not optimally coded—its Huffman codes are calculated with wrong frequencies, and its delta coding will save only about 1 g |CT| per tuple (as opposed to 1 g |T| for tuples in the main table T) Once the change table has grown beyond a threshold, CT is merged with T by redoing the compression on the whole table. The threshold can be determined by the usual policies for merging updates in the warehouse.

Deletion is simpler; we just mark the deleted record with a tombstone flag. The wasted space on the deleted records is reclaimed when CT is merged with T. Updates are handled by changing the field codes for the updated fields in-place, and updating the delta codes for the changed tuple and the following one. This procedure fails if the updated delta codes are longer than before the update; we handle such updates as insert/delete pairs.

3 Querying Compressed Data

We now turn our focus from squeezing bits out of a table to running queries on a squeezed table. Our goals are to:
Design query operators that work on compressed data.
Determine as soon as possible that the selection criteria is not met, avoiding additional work for a tuple.
Evaluate the operators using small working memory, by avoiding access to the Huffman dictionaries.
Evaluate the queries in a pipelined way to mesh with the iterator style used in most query processors.

3.1 Scan with Selection and Projection

Scans are the most basic operation over compressed relations, and the hardest to implement efficiently. In a regular DBMS, scan is a simple operator: it reads data pages, parses them into tuples and fields, and sends parsed tuples to other operators in the query plan. Projection is usually done implicitly as part of parsing. Selections are applied just after parsing, to filter tuples early.

But parsing a compressed table is more compute intensive because all tuples are squashed together into a single bit stream. Tokenizing this stream involves: (a) undoing the delta coding to extract tuplecodes, and (b) identifying field boundaries within each tuplecode. After tokenizing, we need to apply predicates.

Undoing the delta coding. The first tuplecode in the stream is always stored as-is. So we extract it directly, by navigating the Huffman tree for each column as we read bits off the input stream. Subsequent tuples are delta-coded. For each of these tuples, we first extract its delta-code by navigating the Huffman tree for the delta-codes. We then add the decoded delta to the 1 g |R| bit prefix of the previous tuplecode to obtain the 1 g |R| bit prefix of the current tuple. We then push this prefix back into the input stream, so that the head of the input bit stream contains the full tuplecode for the current tuple. We repeat this process till the stream is exhausted.

We make one further optimization to speed decompression. Rather than coding each delta by a Huffman code based on its frequency, we Huffman code only the number of leading 0s in the delta, followed by the rest of the delta in plain-text. This “number-ofleading-0s” dictionary is often much smaller (and hence faster to lookup) than the full delta dictionary, while enabling almost the same compression. Moreover, the addition of the decoded delta is faster when we code the number of leading 0s, because it can be done with a bit-shift and a 64-bit addition most of the time (otherwise we have to simulate a slower 128-bit addition in software because the tuplecodes can be that long).

Identifying field boundaries. Once delta coding has been undone and we have reconstructed the tuplecode, we need to parse the tuplecode into field codes. This is challenging because there are no explicit delimiters between the field codes. The standard approach mentioned in Section 1.1 (walking the Huffman tree and exploiting the prefix code property) is too expensive because the Huffman trees are typically too large to fit in cache (number of leaf entries=number of distinct values in the column). Instead we use a new segmented coding scheme (Section 3.1.1).

Selecting without decompressing. We next want to evaluate selection predicates on the field codes without decoding. Equality predicates are easily applied, because the coding function is 1-to-1. But range predicates need order-preserving codes: e.g., to apply a predicate c₁=c₂, we want: code(c₁)=code(c₂) iff c₁=c₂. However, it is well known [See paper in the 1998 Addison Wesley book to Knuth titled “The Art of Computer Programming“] that prefix codes cannot be order-preserving without sacrificing compression efficiency. The Hu-Tucker scheme [see the paper to Hu et al. titled “Optimal computer search trees and variable-length alphabetic codes” in SIAM J. Appl. Math, 1971] is known to be the optimal order-preserving code, but even it loses about 1 bit (vs optimal) for each compressed value. Segmented coding solves this problem as well.

3.1.1 Segmented Coding

For fast tokenization with order-preservation, we propose

a new scheme for assigning code words in a Huffman tree (our method applies to any prefix code in general). The standard method for constructing Huffman codes takes a list of values and their frequencies, and produces a binary tree [see paper to Huffman titled “Method for the construction of minimum redundancy codes” in the Proc. I.R.E., 1952]. Each value corresponds to a leaf, and codewords are assigned by labelling edges 0 or 1.

The compression efficiency is determined by the depth of each value—any tree that places values at the same depths has the same compression efficiency. Segmented coding exploits this as follows. We first rearrange the tree so that leaves at lower depth are to the left of leaves at higher depth (this is always possible in a binary tree). We then permute the values at each depth so that leaves at each depth are in increasing order of value, when viewed from left to right. Finally, label each node's left-edge as 0 and right-edge as 1. FIG. 2 shows an example. It is easy to see that a segmented coding has two properties:

1) within values of a given depth, greater values have greater codewords (e.g., encode(‘tue’)<encode (‘thu’))

2) Longer codewords are numerically greater than shorter codewords (e.g., encode(‘sat’)<encode (‘mon’))

A Micro-Dictionary to Tokenize CodeWords

Using property 2), we can find the length of a codeword in time proportional to the log of the code length. We don't need the full dictionary; we just search the value ranges used for each code length. We can represent this efficiently by storing the smallest codeword at each length in an array we'll call mincode. Given a bit-vector b, the length of the only codeword that is contained in a prefix of b is given by max{len:mincode[len]=b}, which can be evaluated efficiently using a binary or linear search, depending on the length of the array.

This array mincode is very small. Even if there are 15 distinct code lengths and a code can be up to 32 bits long, the mincode array consumes only 60 bytes, and easily fits in the L1 cache. We call it the micro-dictionary. We can tokenize and extract the field code using mincode alone.

Evaluating Range Queries Using Literal Frontiers

Property 1) is weaker than full order-preservation, e.g., encode(jackfruit)<encode(banana). So, to evaluate λ<col on a literal λ, we cannot simply compare encode(λ) with the field code. Instead we pre-compute for each literal a list of codewords, one at each length: Φ(λ)[d]=max{c a code word of length d| decode(c)≦λ}.

To evaluate a predicate λ<col, we first find the length 1 of the current field code using mincode. Then we check if Φ(λ)[d]<field code. We call Φ(λ) the frontier of λ. Φ(λ) is calculated by binary search for encode(λ) within the leaves at each depth of the Huffman tree. Although this is expensive, it is done only once per query.

Notice that this only works for range predicates involving literals. Other range predicates, such as col1<col2 can only be evaluated on decoded values. In Section 3.3 we discuss how to speed these up by rearranging columns to get locality of dictionary access.

3.1.2 Short Circuited Evaluation

Adjacent tuples being processed in sorted order are very likely to have the same values for many of the initial columns. To take advantage of this, as we devise the plan we determine which columns within the tuple are needed for each partial computation needed for evaluating the selection predicate and the projection results and we track these partial computations on the stack of the scanner.

When processing a new tuple, we first analyze its delta code to determine the largest prefix of columns that is identical to the previous tuple. We use this information to skip into the appropriate place in the plan avoiding much of the parsing and evaluation and retaining all partial results dependent only on the unchanged columns. For scans with low selectivity, this skipping leaves us with no work to do on many tuples—we can already determine that the tuple does not meet the selection criteria.

3.1.3 Scan Iterator Interface

The previous section described how we can scan compressed tuples from a compression block (cblock), while pushing down selections and projections.

To integrate this scan with a query processor, we expose it using the typical iterator API, with one difference—getNext( ) returns not a tuple of values but a tuplecode. The base scan need not decompress the projected columns. If the columns being projected match the sort order of the base table, the columns will still be ordered and instead of producing a sequence of tuplecodes we might choose to re-delta code the result and produce a sequence of cblocks. As usual, the schema to be used for the scan result can be determined either at query compilation or execution time.

By keeping the data compressed as long as possible we reduce significantly the I/O and memory bandwidth required at the expense of additional internal CPU processing. This allows the use of inexpensive computing systems like IBM's CELL processor with limited memory bandwidth and cache size but good compute capabilities.

3.2 Other Query Plan Operators

We now discuss how to layer other query operators of a query plan on top of this scan iterator. We focus on four operators: index-scan, hash join, sort-merge join, and hash-group by with aggregation.

3.2.1 Access Row by RID

Index scans take a bounding predicate, search through an index structure for matching row ids (rids), and then look up the rids in data pages to find the matching records. We are not currently proposing a method for compressing index pages, so the process works as it does in a typical database today. It is only the last step, finding a record from its rid, which must work differently because the record must be extracted from a compression block inside a data page, not just a data page. Because rows are so compact and there are thousands on each data page, we cannot afford a per page data structure mapping the rid to its physical location, thus the rid itself must contain the id of the compression block, which must be scanned for the record. This makes index scans less efficient for compressed data.

TABLE 3
TPC-H vertical partitions used in our experiments. Compression results using
different compression schemes.

| | Data Size (bits) | | | | |
|---|---|---|---|---|---|
| | | | | | Huffman + Concatenation |
| | | Value | Huffman | | of |
| Schema | Original | Coding | Coding | Huffman + Delta | correlated columns |
| I_orderkey, 1_qty | 96 | 37 | 37 | 2.55 | 36 |
| L_orderkey 1_qty 1_orderdate | 160 | 61 | 47.98 | 3.98, 14.52 | 47.98 |
| L_partKey 1_price, | 192 | 76 | 76 | 5.51 | |
| 1_supplierkey, 1_qty | | | | | |
| L_partKey L_supplierNation, | 160 | 68 | 39.54 | 10.63 | |
| L_odate L_customerNation | | | | | |
| ORDERS (all columns in | 472 | 116 | 92.88 | 54.38 | 92.88 |
| orders table) | | | | | |

Random row access is obviously not the best operation for this data structure. Rather, this structure is best used to implement a materialized view that is optimized for scan. In this case indices are not likely to point to records in this type of a table, instead they will point to the data's original home.

3.2.2 Hash Join & Group By with Aggregation

Huffman coding assigns a distinct code word to each value. So we can compute hash values on the code words themselves without decoding. If two tuples have matching join column values, they must hash to the same bucket. Within the hash bucket, the equi-join predicate can also be evaluated directly on the code words.

One important optimization is to delta-code the input tuples as they are entered into the hash buckets. The advantage is that hash buckets are now compressed more tightly so even larger relations can be joined using in-memory hash tables. While the effect of delta coding will be reduced because of the lower density of rows in each bucket, it can still quadruple the effective size of memory.

3.2.3 Group By and Aggregation

Grouping tuples by a column value can be done directly using the code words, because checking whether a tuple falls into a group is simply an equality comparison. However aggregations are harder.

COUNT, COUNT DISTINCT, can be computed directly on code words: to check for distinctness of column values we check distinctness of the corresponding column code words.

MAX and MIN computation involves comparison between code words. Since our coding scheme preserves order only within code words of the same length, we can maintain the current maximum or minimum separately on code words of each length. After scanning through the entire input, we can evaluate the overall max or min by decoding the current code words of each codeword length and computing the maximum of those values.

SUM, AVG, STDEV, etc. cannot be computed on the code words. These operators need to decode the aggregation columns in each tuple of its input. Decoding columns from small domains or those with large skews are quite cheap. Columns with small skews and large domains often benefit from simple inline encoding. Also, by placing the columns early in the sort order there is a higher chance that the scanner will see runs of identical values, improving cache locality during decode.

3.2.4 Sort Merge Join

The principal comparisons operations that a sort merge join performs on its inputs are < and =. Superficially, it would appear that we cannot do sort merge join without decoding the join column, because we do not preserve order across code words of different lengths. But in fact, sort merge join does not need to compare tuples on the traditional ‘<’ operator—any reflexive transitive total ordering will do. In particular, the ordering we have chosen for code words—ordered by codeword length first and then within each length by the natural ordering of the values is a total ordering of values. So we can do sort merge join directly on the coded tuples, without decoding the join column values.

3.3 Exploiting Sort Order for Access Locality

A few query operations need the decoded values of each tuple, such as arithmetic aggregations and comparisons between columns in a tuple. But decoding a column each time can be expensive because it forces us to make random accesses to a potentially large dictionary. One way to avoid random accesses is to exploit sorting to bring like values together so that we can force locality in the dictionary accesses. Interestingly, if we sort these columns early enough then we don't even need to do Huffman coding because the delta coding can compress out the column.

The sort order can also be used to enhance compression by exploiting correlations between columns that were not handled by co-coding the columns. By placing the independent column early and the dependent columns soon afterwards, we can further compress the data. We are developing an optimization model that allows these various demands on the sort order to be balanced.

Note that if the reason for compression is not to save disk space, but to save on I/O processing time, then we can certainly consider maintaining several views of the same data, each with a different set of columns, coding choices, and column sort order that optimizes the runtime of some subset of the workload.

Additionally, the present invention provides for an article of manufacture comprising computer readable program code contained within implementing one or more modules implementing a compression method for relational tables based on combined column and row coding. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) concatenating a plurality of column values forming a combined value to exploit correlation between those columns; (b) encoding column values based on replacing column values with a column code that is a key into a dictionary of column values; (c) concatenating the column codes within each row to form a tuple code; and (c) outputting the tuple code.

### Conclusion

A system and method has been shown in the above embodiments for the effective implementation of a compression method for relational tables based on combined column and row coding. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by specific compression scheme used, software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of database programming.

1. A computer-based method of compressing tabular data, said computer-based method implemented in computer storage and executable by a computer, said computer-based method comprising the steps of:
a. concatenating a plurality of column values forming a combined value to exploit correlation between those columns;
b. encoding column values based on replacing column values with a column code that is a key into a dictionary of column values;
c. concatenating the column codes within each row to form a tuple code; and
d. outputting the tuple code.

2. The computer-based method of claim 1, wherein said step of encoding said column values is done using variable length codes to exploit skew in the frequency of column values.

3. The computer-based method of claim 2, wherein said step of encoding said column values into variable length codes is based on encoding using Huffman codes.

4. The computer-based method of claim 1, wherein said correlation between a plurality of columns is a correlation between adjacent columns.

5. The computer-based method of claim 1, wherein the tuple codes are:
a. sorted in some ordering, and
b. adjacent ordered pairs are coded using a differential coding scheme.

6. The computer-based method of claim 5, wherein computing differences based on said differential coding scheme further comprises:
a. adding random bits to extend short row codes to a given constant length; and
b. computing a difference up to said constant length and placing remainder of row codes, as is.

7. The computer-based method of claim 5, wherein computing differences further comprises:
a. when a short code follows a long code, appending a plurality of zeros to said short code to allow delta to be computed;
b. when a short code follows a long code, extending said short code by copying corresponding bits from said long code, resulting in a delta that begins and ends with a plurality of zeros.

8. The computer-based method of claim 5, wherein computing differences further comprises:
a. when a short code follows a long code, appending a plurality of zeros to said short code to allow delta to be computed;
b. when a short code follows a long code, coding a shortest difference that results in a row code with a correct prefix, and co-coding a difference in length between said long code and said short code.

9. The computer-based method of claim 5, wherein said differential encoding scheme uses Huffman codes and said step of computing differences further comprises Huffman coding a difference or Huffman coding a length of runs of binary zeros in the prefix and suffix of said difference.

10. The computer-based method of claim 5, wherein said differential coding scheme is a histogram coding scheme.

11. The computer-based method of claim 5, wherein said sorting step is a lexicographical sort.

12. The computer-based method of claim 1, wherein said tabular data structure is associated with a database.

13. The computer-based method of claim 1, wherein an order of column concatenation is chosen to increase a probability of small differences by adding repeated independent columns, followed by dependent columns, following by a remainder of independent columns.

14. A computer based method of claim 1, wherein columns names and column values are derived from the tags and entries of a structured or semi-structured object.

15. A computer based method of claim 14, where data to be compressed is in XML format and each entry name and attribute name is used as a column name, and the entry value or attribute value is used as a column values.

16. A computer based method of claim 14, where data to be compressed is in XML format and the labeled paths in the XML tree are used as column names, and the entry or attribute value is used as a column value.

17. A computer based method of claim 2 where codes of each length are assigned in an order that is compatible with a collation order of the column values and where range and equality queries over column values are translated into a query over the column codes for the purpose of faster query execution.

18. An article of manufacture a computer user medium having computer readable program code embodied therein which implements a method of compressing a tabular data structure, said medium comprising:
a. computer readable program code concatenating a plurality of column values forming a combined value to exploit correlation between those columns;
b. computer readable program code encoding column values based on replacing column values with a column code that is a key into a dictionary of column values;
c. computer readable program code concatenating the column codes within each row to form a tuple code; and
d. computer readable program code outputting the tuple code.

19. The article of manufacture of claim 18, wherein said encoding of said column values is done using variable length codes to exploit skew in the frequency of column values.

20. The article of manufacture of claim 19, wherein said encoding of said column values into variable length codes is based on encoding using Huffman codes.

21. The article of manufacture of claim 19, wherein said correlation between a plurality of columns is a correlation between adjacent columns.

22. The article of manufacture of claim 18, wherein the tuple codes are:
a. sorted in some ordering, and
b. adjacent ordered pairs are coded using a differential coding scheme.

23. The article of manufacture of claim 22, wherein computing differences based on said differential coding scheme further comprises:
a. adding random bits to extend short row codes to a given constant length; and
b. computing a difference up to said constant length and placing remainder of row codes, as is.

24. The article of manufacture of claim 22, wherein computing differences further comprises:
a. when a short code follows a long code, appending a plurality of zeros to said short code to allow delta to be computed;
b. when a short code follows a long code, extending said short code by copying corresponding bits from said long code, resulting in a delta that begins and ends with a plurality of zeros.

25. The article of manufacture of claim 22, wherein computing differences further comprises:
a. when a short code follows a long code, appending a plurality of zeros to said short code to allow delta to be computed;
b. when a short code follows a long code, coding a shortest difference that results in a row code with a correct prefix, and co-coding a difference in length between said long code and said short code.

26. The article of manufacture of claim 22, wherein said differential coding scheme is a histogram coding scheme.

27. The article of manufacture of claim 18, wherein an order of column concatenation is chosen to increase a probability of small differences by adding repeated independent columns, followed by dependent columns, following by a remainder of independent columns.

28. The article of manufacture of claim 18, wherein columns names and column values are derived from the tags and entries of a structured or semi-structured object.

29. The article of manufacture of claim 28, where data to be compressed is in XML format and each entry name and attribute name is used as a column name, and the entry value or attribute value is used as a column values.

30. The article of manufacture of claim 28, where data to be compressed is in XML format and the labeled paths in the XML tree are used as column names, and the entry or attribute value is used as a column value.
